(19) United States
(12) Patent Application Publication
(10) Pub. No.: US 2014/0050648 A1
(43) Pub. Date: Feb. 20, 2014

(54) PREPARATION OF CHLOROSILANES FROM VERY FINELY DIVIDED ULTRA-PURE SILICON

(71) Applicants: Frank Becker, Offenbach am Main (DE); Wolfgang Wienand, Bergisch Gladbach (DE); Ingo Pauli, Schmitten (DE); Maciej Olek, Kahl (DE); Yücel Önal, Carl Junction, MO (US)

(72) Inventors: Frank Becker, Offenbach am Main (DE); Wolfgang Wienand, Bergisch Gladbach (DE); Ingo Pauli, Schmitten (DE); Maciej Olek, Kahl (DE); Yücel Önal, Carl Junction, MO (US)

(73) Assignee: Evonik Degussa GmbH, Essen (DE)

(21) Appl. No.: 13/988,029

(22) PCT Filed: Nov. 9, 2011
(86) PCT No.: PCT/EP11/69737

§ 371 Date: Aug. 6, 2013

(30) Foreign Application Priority Data
Nov. 18, 2010 (DE) 10 2010 044 108.2

(51) Int. Cl. C01B 33/107

(52) U.S. Cl. CPC C01B 33/10742
USPC 423/342

(57) ABSTRACT

The invention provides a process and apparatus for preparing chlorosilane from the reaction of very finely divided ultra-pure silicon with hydrogen chloride, the very finely divided ultra-pure silicon being fed into a solid bed of metallurgical silicon, the feed line for ultra-pure silicon and the fixed bed having a certain minimum temperature.

The invention relates to an apparatus and to a process for preparing chlorosilanes from ultrafine ultrapure silicon. The starting material used may especially be ultrafine or fine ultrapure silicon which is, more particularly, ultrapure silicon waste (kerf). The ultrafine ultrapure silicon preferably has a purity of the particles of >99.99% Si, preferably >99.9999% Si, for example silicon dust which is obtained in the deposition of silicon from gaseous silicon compounds in a fluidized bed reactor or Siemens reactor, or sawing and grinding particles which are produced in the course of mechanical processing, especially in the course of sawing or grinding of ultrapure silicon. Such ultrafine ultrapure silicon is also referred to as kerf and may be mixed with sawing material, grinding material and/or coolant, for example with iron, diamond, silicon carbide and organic coolant. Ultrafine silicon particles refer to those having sizes in the region of less than 50 μm, preferably less than 10 μm. The process according to the invention converts ultrafine ultrapure silicon in the hydrochlorination, with presence of what is called metallurgical silicon having <99.9% Si, e.g. 98% Si, the remainder being Fe, Ca and Al, in a mixture with the ultrafine ultrapure silicon. The metallurgical silicon generally has much larger particles with a size exceeding 1 cm. According to the invention, the ultrafine ultrapure silicon is converted in a fixed bed reactor, preferably by means of a gas stream comprising hydrogen chloride, at temperatures of at least 380° C., preferably at least 450° C. and more preferably at least 750° C., to gaseous silicon-chlorine compounds, e.g. SiHCl₃ and/or SiCl₄. The fixed bed reactor used in the process has a grid, a bed of metallurgical silicon above the grid, an inlet for hydrogen chloride as the HCl addition, and an inlet heated to at least 380° C., preferably at least 450° C., for the thus heated feeding of the ultrafine ultrapure silicon. The process according to the invention advantageously allows the use of a reactor with a cooling device consisting of a cooling jacket in the wall and/or lid, and said reactor does not need, for example, any device for supply of a cooling medium to the reactor volume.

For the process according to the invention the conversion of the silicon-containing particles to gaseous silicon-chlorine compounds by reaction with hydrogen chloride gas essentially free of chlorine gas is envisaged. This is because the reaction of silicon with hydrogen chloride gas to give SiHCl₃ or SiCl₄, at −219 kJ/mol and −272 kJ/mol respectively, is much less exothermic than the reaction of silicon with chlorine, such that the process according to the invention does not need any internal cooling, for example by additional internal heat exchange surfaces.

### STATE OF THE ART

Bade et al., in Int. J. Miner. Process. 167-179 (1996), state that metallurgical silicon which is produced by reduction of silicon dioxide with carbon contains about 90% Si and 5-7% Fe. The metallurgical silicon is first reacted with hydrogen chloride to give SiHCl₃ and/or SiCl₄, and the latter is removed, condensed and subsequently deposited, for example in the Siemens process, to give ultrapure silicon. The synthesis is typically conducted in fluidized bed reactors (Ullmann, 2005). Typical particle sizes in fluidized bed reactors are around 250 μm; typical reaction temperatures are around 300° C. (Lobreyer et al., 1996).

US 2005/0226803 A1 describes the preparation of trichlorosilane from ultrafine silicon by means of reaction with hydrogen chloride in a fluidized bed, the silicon being introduced directly into the fluidized bed. The ultrafine silicon used is dust obtained in the production of metallurgical silicon chunks, which was obtained in the example in the course of grinding of metallurgical silicon with 1.4% Fe, 0.2% Al and 0.015% Ca.

US2007/0231236 A1 describes the removal of grinding materials by centrifugation of liquid with ultrafine ultrapure silicon suspended therein in a first centrifugation and subsequent removal of the solids from the liquid by centrifugation. After comminution of the residue for surface activation of the silicon, the ultrapure silicon is halogenated alone, more particularly with chlorine or hydrogen chloride.

WO 2008/133525 describes the conversion of ultrafine ultrapure silicon which is obtained as sawdust (kerf) in a mixture with silicon carbide or metal particles in the processing of ultrapure silicon ingots, in a mixture with metallurgical silicon which is present as a bed, which is also referred to as a fluidized bed, in the reactor, and through which chlorine gas flows. The particles discharged with the gas stream are recycled into the reaction zone. Due to the strongly exothermic reaction of the silicon sawdust in the fluidized bed, internal cooling of the fluidized bed with liquefied SiCl₄ in combination with the supply of this ultrafine ultrapure silicon in a mixture with the liquefied SiCl₄ is recommended.

DE 10 2004 05919 B4 discloses, by way of example, an embodiment and mode of operation of a fixed bed reactor for preparation of chlorosilanes.

### OBJECT OF THE INVENTION

It is an object of the invention to provide a process for hydrochlorination of ultrafine ultrapure silicon, which allows simple conversion of various ultrapure silicon wastes. The aim is that the process proceeds with a cooling device which has a simple reactor and consists, for example, only of the cooling of the reactor via the wall and/or lid thereof. More preferably, the process shall avoid recycling of silicon particles discharged from the reactor.

### GENERAL DESCRIPTION OF THE INVENTION

In the preparation of the invention, it has been found that ultrafine ultrapure silicon can form a high-viscosity material on contact with hydrogen chloride-containing gas. It has also been found that ultrafine ultrapure silicon can exhibit uneconomically low yields in the reaction with hydrogen chloride. In contrast, ultrafine metallurgical silicon can be efficiently hydrochlorinated without observation of the formation of a viscous phase or uneconomic yields.

Ultrafine ultrapure silicon which is used in the process according to the invention is preferably produced by one of the following processes: by mechanical processing of blocks of ultrapure silicon, for example by sawing and/or polishing, such that the fine ultrapure silicon is present in a mixture with organic coolant, for example sawing material, coolant, and/or with grinding materials, for example diamond or silicon carbide. Ultrafine ultrapure silicon used in the process can be produced by deposition of ultrapure silicon in fluidized bed reactors or Siemens reactors, since these processes produce not only the bulk ultrapure silicon target product but also ultrafine dusts of ultrapure silicon. More preferably, the ultrafine ultrapure silicon has particle sizes in the range from 1 nm to 50 μm, preferably 100 nm to 10 μm.

The invention achieves the object with the features of the claims and provides, more particularly, a continuous process for preparing chlorosilane from ultrafine ultrapure silicon in a fixed bed reactor operated with hydrogen chloride and metallurgical silicon.

According to the invention, the ultrafine ultrapure silicon is introduced heated into the reactor. In order to avoid the formation of a high-viscosity material with the consequence of blockage, the inlet pipe for ultrafine ultrapure silicon is heated to at least 380° C., preferably to at least 450° C. This heating of the inlet for ultrafine ultrapure silicon also avoids the formation of a viscous phase in the reactor which forms at lower temperatures on contact of the ultrafine ultrapure silicon with hydrogen chloride. It is generally preferable for the introduction of ultrafine ultrapure silicon and hydrogen chloride-containing gas to be effected continuously; optionally, the supply of metallurgical silicon for production of the fixed bed is also effected continuously.

In this case, the ultrafine ultrapure silicon can be added via a heated inlet which is separate from the inlet for hydrogen chloride and ends, for example, in a stub with a feed orifice above or below the grid. This arrangement of the feed orifice of the inlet or of the stub, preferably in the lower region of the fixed bed, achieves high residence times of the ultrafine ultrapure silicon, such that it is converted essentially completely within the residence time during the passage through the fixed bed, and no ultrafine ultrapure silicon is discharged from the reactor with the gaseous reaction products. In a first embodiment, the heated inlet pipe which connects the source for ultrapure silicon to the outlet orifice thereof may have a slope toward the feed orifice sufficient for the transport of the ultrapure silicon. In another version, the ultrafine silicon is conveyed pneumatically by means of a gas stream, for example by means of a nitrogen stream. Hydrogen chloride is supplied as a hydrogen chloride-containing gas below the bed, with optional heating also of the inlet for hydrogen chloride-containing gas, for example at the temperature of the reactor or the temperature of the inlet for ultrafine ultrapure silicon. In this embodiment, in which ultrafine ultrapure silicon is generally introduced into the reactor in an inlet separate from the inlet for hydrogen chloride-containing gas, the metallurgical silicon which forms the fixed bed is introduced into the reactor, optionally in a mixture with the ultrafine ultrapure silicon.

In a second embodiment, the ultrafine ultrapure silicon is introduced into the reactor together with the hydrogen chloride reactant via a common heated inlet or via the same heated stub, and added through a feed orifice disposed below the grid. This achieves an advantageously large residence time of the ultrapure silicon in the fixed bed reactor.

In a third embodiment, the ultrafine ultrapure silicon can be added to the fixed bed together with optionally added chlorosilane or hydrogen via a heated inlet or via a heated stub. By means of additional feeding of chlorosilane or hydrogen, the product gas equilibrium of the reaction can be influenced, such that the process can be controlled as a result.

In a particular embodiment of the invention, the ultrafine ultrapure silicon, prior to addition to the reactor, is comminuted to an even more advantageous particle size, for example to average particle sizes of not more than 10 μm. In this case, for example, ultrafine ultrapure silicon comminuted in a mill is supplied, and the process has the step of comminution of ultrafine ultrapure silicon prior to the introduction thereof into the reactor.

Accordingly, an inventive apparatus for use in the process features heating of the inlet pipe for ultrafine ultrapure silicon which has optionally additionally been comminuted, and optionally for hydrogen chloride-containing gas and/or tetrachlorosilane, and further optionally additionally hydrogen and/or nitrogen, to at least 380° C., preferably to at least 400° C. or to at least 450° C. The inlet pipe may have a heating device. Alternatively, the inlet pipe can be heated by virtue of the hydrogen chloride-containing gas supplied to the inlet pipe, including the ultrafine ultrapure silicon, having at least the temperature of the inlet pipe, in which case, for example, a heating device disposed on the inlet pipe outside the reactor is used to heat the hydrogen chloride-containing gas and/or the ultrafine silicon to at least 380° C., preferably at least 400° C. or 450° C., preferably to a temperature 50 to 200 K higher than the temperature to which the inlet pipe is heated. It has been found that, for the intended reaction, the fixed bed should be operated at a temperature of at least 380° C., preferably at least 450° C., more preferably at least 750° C. to not more than 1410° C., the melting temperature of silicon, in order to avoid the formation of a viscous phase and to achieve sufficient yields.

The fixed bed itself consists of metallurgical silicon and ultrafine ultrapure silicon introduced into the reactor. The metallurgical silicon which forms the bed is introduced from a geodetically higher reservoir from above into the fixed bed, either batchwise or continuously. The ash resulting from conversion of the metallurgical silicon falls through the grid into a lower ash outlet of the reactor disposed, for example, in the base region of the reactor.

One advantage of this process lies in the use of a simple fixed bed reactor compared to a complex fluidized bed reactor, which suffers high abrasion of the wall material in operation. The apparatus for use in the process therefore has a reactor with a fixed bed of metallurgical silicon, with an inlet for supply of metallurgical silicon, with an inlet for supply of hydrogen chloride-containing gas and an inlet for supply of ultrafine ultrapure silicon, or alternatively with an inlet for a mixture with hydrogen chloride-containing gas with ultrafine ultrapure silicon, with heating at least of the inlet for supply of ultrafine silicon, and optionally additionally the inlet for hydrogen chloride-containing gas, to at least 380° C., preferably to at least 450° C. The feed orifice of the heated inlet for hydrogen chloride-containing gas is preferably arranged below or within the zone of the reactor in which the fixed bed is formed. The feed orifice of the heated inlet for ultrafine ultrapure silicon is preferably disposed below or within the zone of the reactor in which the fixed bed is formed. The feed orifice of a heated common inlet for ultrafine ultrapure silicon in a mixture with hydrogen chloride-containing gas is preferably disposed below or within the zone of the reactor in which the fixed bed is formed. More preferably, the feed orifice of the inlet for ultrafine silicon is disposed in a section of the reactor in which the fixed bed is formed, this section during the process having a temperature of at least 380° C. The exothermicity, which is moderate compared to direct chlorination, can be removed in accordance with the invention, for example, exclusively via the reactor wall. The fixed bed reactor should be operated at a temperature of at least 380° C., preferably at least 450° C., more preferably at least 750° C. up to a maximum of 1410° C., the melting temperature of silicon. This firstly avoids the formation of highly viscous material; secondly, the high temperatures lead to a sufficiently high yield of added ultrafine ultrapure silicon. A significant advantage of the inventive use of a fluidized bed reactor over a complex fixed bed reactor also lies in the substantial absence of abrasion of the wall material of the reactor.

The reactor finally has an outlet for the product gases, for example SiHCl₃ and SiCl₄, and this may optionally have a separator, for example a filter or cyclone, for particles, and may be connected by a line to a condenser for SiHCl₃ and/or SiCl₄. Optionally, gaseous SiHCl₃ and/or SiCl₄ can be recycled into the reactor through the heated inlet, in which case the gaseous SiHCl₃ and/or SiCl₄ serves, for example, as an inert carrier gas for pneumatic delivery of ultrafine ultrapure silicon.

### DETAILED DESCRIPTION OF THE INVENTION

The invention is now described in detail with reference to the examples. In the example reactions, unless stated otherwise, 50 g of ultrafine ultrapure silicon compacted by pressing and having a mean particle size around 200 μm were arranged in each case as a fixed bed on a grid in a reactor. Hydrogen chloride gas was supplied from the bottom into the fixed bed with a flow rate of 1.5 cm/s. The feed for hydrogen chloride gas was heated to the reactor temperature specified in each case. The ultrafine ultrapure silicon particles used for pressing were sawdust which had been obtained by sawing a block of ultrapure silicon. The product gas leaving the reactor was filtered, condensed and analyzed by means of NMR.

### Comparative Example 1

### Ultrapure Silicon Particles and HCl at 380° C.

In a first experiment with reaction parameters typical of a fluidized bed reactor, the ultrapure silicon particles were reacted with hydrogen chloride at 380° C. At this temperature, no formation of gaseous chlorosilanes was detectable. Instead, a highly viscous product formed in the reactor. It is assumed that chlorosilanes formed react with other constituents of the ultrafine ultrapure silicon, and so essentially no gaseous chlorosilanes were detected at the reactor outlet.

### Comparative Example 2

### Hydrochlorination of Ultrapure Silicon at 450° C.

Comparative example 1 was repeated at a reactor temperature of 450° C. At this temperature, gaseous chlorosilanes were detectable at the reactor outlet. No highly viscous product formed any longer. However, the reaction stopped after a low yield of the ultrapure silicon of about 8%.

### Comparative Example 3

Hydrochlorination of Ultrapure Silicon at 750° C.

Comparative example 1 was repeated at a temperature of 750° C. in the reactor. Again, gaseous chlorosilanes were detected at the reactor outlet. No highly viscous product was formed. It was found that the conversion to chlorosilane proceeded with a distinctly increased yield of 15%.

This example shows that the hydrochlorination reaction is in competition with suspected conglutination of the ultrapure silicon, and that relatively high reaction temperatures accelerate the hydrochlorination reaction to a greater degree than the conglutination.

### Comparative Example 4

### Hydrochlorination of Comminuted Ultrapure Silicon at 450° C.

Comparative example 2 was repeated, except that compacted ultrafine ultrapure silicon comminuted by means of a mortar was used as the material for the fixed bed. Again, gaseous chlorosilanes were detected at the reactor outlet. No highly viscous product formed. At the same time, the yield of ultrapure silicon after the reaction had stopped was found to be distinctly increased and, at 17%, was about twice that in comparative example 2, in which coarser ultrafine ultrapure silicon was converted.

This example shows that not only an increased reaction temperature but, more particularly, also a comminution or addition of more finely divided ultrapure silicon allows the conversion of ultrafine ultrapure silicon to be conducted much more effectively. This addition of ultrafine ultrapure silicon results, in accordance with the invention, from the addition thereof to the fixed bed reactor in a hydrogen chloride-containing gas stream.

### Example 1

### Hydrochlorination of Ultrapure Silicon and Metallurgical Silicon at 450° C.

In contrast to the comparative examples, a bed of metallurgical silicon of the 150 to 250 μm fraction was arranged as a fixed bed on the grid of the reactor. The ultrafine ultrapure silicon was comminuted by grinding to a particle size of less than 50 μm and introduced in a mixture with hydrogen chloride through an inlet heated to 450° C. below the fixed bed. The fixed bed was heated to 450° C. by heating the reactor. No highly viscous product formed. Again, gaseous chlorosilanes were detected at the reactor outlet. Compared to comparative example 2, a distinct rise in the yield of ultrapure silicon was detected.

This example shows that an efficient conversion of the ultrafine ultrapure silicon is possible in industrial standard fixed bed reactors with metallurgical silicon. Fine distribution of the ultrapure silicon by grinding thereof additionally enhances the yield.

1. A process for preparing a gaseous chlorine-silicon compound, the processing comprising reacting ultrafine ultrapure silicon with a gas comprising hydrogen chloride in a reactor having a fixed bed,
wherein the fixed bed comprises metallurgical silicon and the ultrafine ultrapure silicon is introduced through an inlet heated to at least 380° C,. below or within a zone of the reactor in which the fixed bed is formed, and the gas comprising hydrogen chloride is introduced below or within the zone of the reactor in which the fixed bed is formed, and the fixed bed is at a temperature above 380° C.

2. The process of claim 1,
wherein the fixed bed is at a temperature above 450° C. and at most 1410° C.

3. The process of claim 1,
wherein the fixed bed is at a temperature above 750° C. and at most 1410° C.

4. The process of claim 1, wherein
the ultrafine ultrapure silicon and the gas comprising hydrogen chloride are introduced through a common heated inlet below or within the zone of the reactor in which the fixed bed is formed.

5. The process of claim 1, wherein
the ultrafine ultrapure silicon is introduced in a mixture comprising at least one selected from the group consisting of chlorosilane, hydrogen and nitrogen, through the inlet.

6. The process of claim 1, wherein
the inlet comprises a heating device in a section in which the ultrafine ultrapure silicon is present.

7. The process of claim 1, wherein
the gas comprising hydrogen chloride, the ultrafine ultrapure silicon, or both, is heated prior to entry into the inlet to at least 380° C.

8. The process of claim 1, wherein
the ultrafine ultrapure silicon, prior to supply to the reactor, is comminuted partly or fully, continuously or batchwise.

9. The process of claim 1, wherein
a material of the fixed bed is added through the inlet together with the ultrafine ultrapure silicon.

10. The process as of claim 1, wherein
the reactor is cooled entirely by a wall of the reactor, a lid of the reactor, or both.

11. The process of claim 1, wherein
gaseous SiHCl₃, gaseous SiCl₄, or both, is passed into the reactor in a mixture with the ultrafine ultrapure silicon.

12. The process of claim 1, wherein a feed device, suitable for feeding metallurgical silicon opens within or above the zone of the reactor in which the fixed bed is formed.

13. The process of claim 1, wherein
the reactor comprises a cooling device with a heat transfer area consisting of a wall of the reactor.

14. The process of claim 1, wherein the reactor further comprises a
comminution device.

15. (canceled)

16. The process of claim 2, wherein the ultrafine ultrapure silicon and the gas comprising hydrogen chloride are introduced through a common heated inlet below or within the zone of the reactor in which the fixed bed is formed.

17. The process of claim 3, wherein the ultrafine ultrapure silicon and the gas comprising hydrogen chloride are introduced through a common heated inlet below or within the zone of the reactor in which the fixed bed is formed.

18. The process of claim 2, wherein the ultrafine ultrapure silicon is introduced in a mixture comprising at least one selected from the group consisting of chlorosilane, hydrogen and nitrogen, through the inlet.

19. The process of claim 3, wherein the ultrafine ultrapure silicon is introduced in a mixture comprising at least one selected from the group consisting of chlorosilane, hydrogen and nitrogen, through the inlet.

20. The process of claim 4, wherein the ultrafine ultrapure silicon is introduced in a mixture comprising at least one selected from the group consisting of chlorosilane, hydrogen and nitrogen, through the inlet.

21. The process of claim 1, wherein the gas comprising hydrogen chloride, the ultrafine ultrapure silicon, or both, is heated prior to entry into the inlet to at least 400° C.
